(19) United States
(12) Patent Application Publication
(10) Pub. No.: US 2002/0099569 A1
(43) Pub. Date: Jul. 25, 2002

(54) System and method for adaptive transmission of information

(75) Inventor: Graham Thirsk, Everett, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Connex MD, Inc.

(21) Appl. No.: 09/923,781

(22) Filed: Aug. 6, 2001

Related U.S. Application Data
(60) Provisional application No. 60/222,953, filed on Aug. 4, 2000.

(51) Int. Cl. G06F 17/60

(52) U.S. Cl. 705/2

(57) ABSTRACT

A system and method for adaptive transmission of information is disclosed. An end-user may control the amount of image information received at review station. The user receives frames of images until certain information is identified. The user may request to receive more detailed information based on the identified information.

### CROSS-REFERENCE TO RELATED APPLICATION

The present application claims the benefit of U.S. Provisional Application No. 60/222,953 filed Aug. 4, 2000.

### FIELD OF THE INVENTION

This invention relates to a system and method for acquiring, transmitting, and reviewing medical or diagnostic information over a network in a manner that reduces the data size and associated transmission bandwidth while streamlining the data to match clinician workflow procedures.

### BACKGROUND OF THE INVENTION

There is increasing awareness of the economic and clinical advantages to be gained by using a centralized group of “expert” clinicians to review and interpret ultrasound or other images acquired at a remote location. A major challenge to providing this remote diagnostic capability is the transfer of high bandwidth continuous data streams without loss of clinical diagnostic information.

Current communications infrastructure barely meets the bandwidth requirements for real-time image streams and the costs are considerable. For example, the cost associated with installing and maintaining T1 lines to acquire sufficient bandwidth are often probative.

In order for lower cost networking alternatives such as Digital Subscriber Lines (DSL) or Integrated Services Digital Network (ISDN) lines to be viable for clinical image applications, a substantial reduction in the amount of data transferred, without loss of clinically significant data, is required. The traditional approach is to use conventional data compression techniques to reduce the transmitted data size. Using conventional compression methods, however, compression rates higher than about 4:1 cannot be achieved without the use of lossy compression algorithms and the associated risk of loss of diagnostically useful information.

In addition, prior art schemes for the network transmission of clinical data do not correlate well with current clinical workflow practices. Resources are often wasted by transmitting more information than necessary for effective clinical review, or transmitting large amounts of data that is not required for the diagnostic review. Additional resources such as clinician's time are then typically wasted waiting for unnecessarily large images to transmit.

Furthermore, the views of transmitted data are typically not presented to the clinical review in an efficient sequence. For example, in various ultrasound, angiogram, x-ray and other image collection procedures a prescribed collection of views, either single frame or dynamic sequences, are initially acquired with additional views acquired if clinically appropriate. The prescribed views are typically selected to provide the reviewing physician with an anatomical and/or physiological overview. The views are acquired, and transmitted, in the order of acquisition which may not be the most efficient clinical review sequence.

Other drawbacks of existing schemes exist.

### SUMMARY OF THE INVENTION

It is an object of the invention to overcome these and other drawbacks of present systems and methods.

It is another object of the invention to provide a system and process for enabling the acquisition, identification, and adaptive review of clinical diagnostic images.

To achieve these objects and in accordance with the purpose of the invention, there are provided a system and method for acquiring clinical image data which includes identifying the images acquired with a label that enables the identity of the image to be determined. Furthermore, present invention enables adaptive review of the sequence of clinical image data under the direction of a reviewing image requester. The invention permits select images to be transmitted and/or compression of images.

The accompanying drawings, which are incorporated in and constitute a part of this specification, illustrate an embodiment of the invention and, together with the description, serve to explain the principles of the invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flowchart illustrating a method for adaptive transmission of information according to an embodiment of the invention.

FIG. 2 is a flowchart illustrating a more detailed representation of the adaptive review step shown in FIG. 1, according to an embodiment of the invention.

FIG. 3 is a schematic diagram of a system for implementing the adaptive transmission of information shown in FIG. 1, according to an embodiment of the invention.

### DETAILED DESCRIPTION OF THE PREFERRED EMBODIMENT

A study of current clinical workflow practices for reviewing diagnostic images revealed that clinical reviewers in medical and other applications mentally filter images that are judged to be “normal” from the image set, and concentrate attention on those that do not meet “normal” criteria. The definition of normal varies with application and reviewer.

For example, in cardiology applications, the examination may be reviewed from videotape in “search mode.” The images are viewed initially at high speed with consequent reduction in spatial and temporal resolution. The videotape is only viewed at regular speed if the anatomy and/or physiology is unclear or an abnormality is observed. In this way, the reviewer can condense the 20 minutes of videotape recorded from a typical 45-minute examination to approximately 3 minutes of viewing time, for a better than 6:1 compression rate.

Similarly, in radiology, 20-40 images may be printed on 6-10 sheets of film, which are mounted on a continuous viewer running the images past a light box. The reviewer scans the image set for images with an “abnormal” appearance, concentrates attention on the identified abnormal images, and dictates a report. On average, 80-90% of the images from such an examination are deemed to be “normal” and therefore otherwise ignored. The reviewer often re-orders the image sequence for a more efficient review.

In obstetrics, the ultrasound examination may be reviewed from videotape or from a number of image frames on some form of hard copy. In either case, the process of separating “normal” from “abnormal” images still applies.

Based upon these and other observations, the inventor has identified at least the following five principles that are applied individually or in combination in embodiments of the present invention.

First, many images do not have to be viewed at full spatial or temporal resolution in order to be identified as normal and consequently of reduced clinical importance. Second, images that cannot be determined as normal or abnormal by the reviewer when at a lower resolution are viewed at increasing spatial and/or temporal resolution until such determination can be made. Third, the reviewer determines the diagnostic significance of images so the reviewer, rather than the acquirer, must control the appropriate image resolution during review. Fourth, images should be available to the reviewer in the highest acquisition resolution, on demand. Fifth, the acquisition sequence is not necessarily the optimum sequence for transmission, review and/or determination of clinical significance; optimizing the order or sequence of views to match review workflow may improve efficiency and reduce the number of images that must be transmitted.

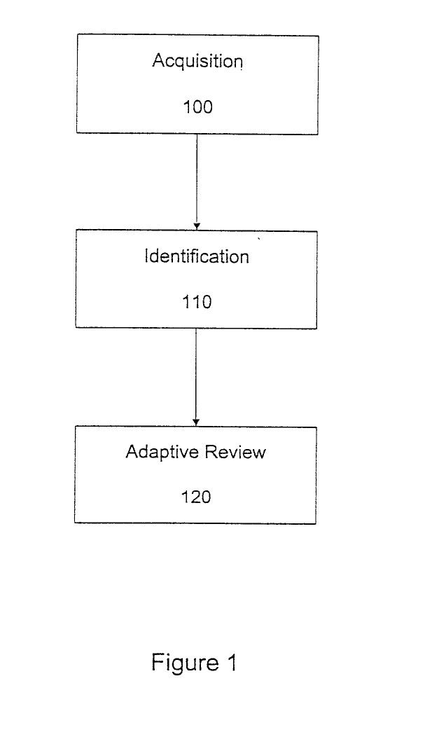

FIG. 1 is a flow chart showing schematically an overall process for the acquisition and review of clinical images according to an embodiment of the invention. As shown, the process may include acquisition of clinical diagnostic images at step 100, identification of the acquired images at step 110 and adaptive review of the identified images at step 120. It is to be understood that, while FIG. 1 shows sequential steps, in practice the portions of the steps may overlap or occur simultaneously. Each step is explained more completely below.

Acquisition

The acquisition step 100 entails the recording of clinical diagnostic images. The acquisition step 100 may vary according to the particular diagnostic test and/or device being performed and utilized. For example, methods of recording sonogram images, angio-cardiogram images, x-rays, etc., all involve different procedures.

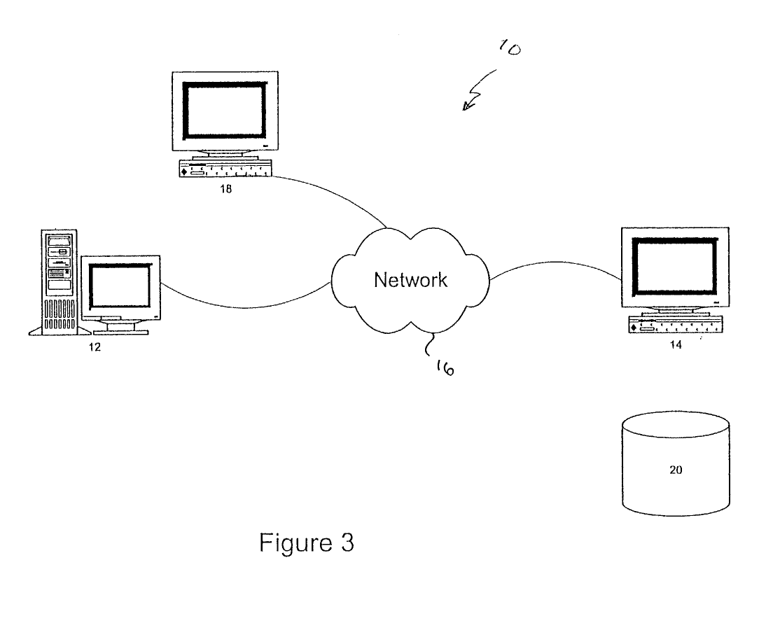

In any case, once the images are recorded and available in an appropriate format, they may be loaded into a suitable file or service providing device, such as a server or retrievable storage device (for example, the system 10 in FIG. 3).

The images may be loaded in any suitable fashion, as are well known in the art. For example, some embodiments of the invention may include a direct connection (hard-wired or wireless) between the clinical imaging device and the server so that the clinical images are simultaneously loaded into the server as they are being acquired. Other alternatives, by way of non-limiting example, include: storing recorded images on a suitable processor readable disc (e.g., hard disk drive, floppy disk drive, zip disk drive, etc.) for later loading onto the server; producing hard copies of the images (e.g., developing x-ray film); and scanning hard copy into digital form for loading. The present invention may be implemented using any suitable method of loading digital images onto the server.

It is also noted that the images will typically be recorded in a manner suitable to the diagnostic application. For example, a clinician may record images as single frames or dynamic sequences as desired or appropriate to the examination being performed.

In some embodiments, the data may be stored in a lossless form. Preferably, the data is stored losslessly, or at least without the loss of clinically important data, by implementing the procedures described in the co-pending provisional application by the same inventor titled, “Method and Apparatus for Providing Clinically Adaptive Compression of Image Data,” U.S. Provisional Application No. 60/222,952.

Identification

The identification step 110 entails labeling the acquired images so that individual images may be identified. In some embodiments of the present invention the images may be identified by a predefined label. Images may be labeled as they are acquired, as they are loaded on the server, in batch mode after loading, or at another appropriate time. Labeling the images enables a reviewing physician to request specific views or images if desired or to facilitate transmission of images in the most relevant and/or efficient sequence.

Adaptive Review

The adaptive review occurs at step 120. The adaptive review 120 occurs when a requester (for example, a physician or other image interpreter) makes a request for network image delivery. Upon request, the system provides images to the requester in an efficient, feedback responsive manner that is controllable by the requester.

One embodiment of the invention may be described with reference to the following example wherein a physician (requester) makes a request to review diagnostic ultrasound images. As discussed above, the reviewing physician screens the ultrasound images for “normal” appearance and concentrates on those that are either unrecognized or “abnormal.” It is not always necessary for the images to be at maximum resolution to determine that a given image is normal or abnormal.

Referring now to FIG. 3, initially, requested images are forwarded by a server 12 to a review station 14 in a compressed form that is preselected to optimize transmission time and quality. It will be readily apparent that the highest quality images, that is, images with the highest temporal and/or spatial resolution, will be the largest and therefore require more transmission time. Therefore, an optimal balance between transmission time and image quality will exist. In this embodiment, for example, only the first frame of a dynamic sequences is forwarded at this time. In this manner, the physician is able to obtain an overview of the available images in a scrollable area of the review station 14 display relatively quickly. While the physician is reviewing these overview images, the remaining frames of any dynamic sequences may be compressed and forwarded.

In a preferred embodiment, the reviewing physician may interrupt this process at any time by selecting one or more images for closer inspection. If the selected images are from a dynamic sequences, then the server 12 may transmit any remaining frames for those images while the first frames are under review at review station 14. The additional frames may be forwarded using an algorithm to minimize the transmission delays.

For example, in a preferred embodiment when additional frames are requested, server 12 transmits the middle frame of a dynamic sequence (i.e., an index frame) and a frame on either side of the indexed frame (e.g., frames 5, 10, 15). Intermediate frames are then transmitted to “fill in” the data set. This scheme presents the physician with an increasingly more detailed view of the examination, by continually bisecting the selected range of full frames. In other words, frames 5, 10, 15 are transmitted first, then frames 7 and 13, then frames 6, 8, 12, 14, and finally frames 9 and 11. In some embodiments, this fill process may continue until the reviewer signals that sufficient data has been received. The optimum sequencing may be linked to clinical application and network parameters for optimum performance.

In some embodiments, the reviewing physician may also request the images in a less compressed form, up to the lossless form stored on the server. In other words, the physician may not immediately desire additional images in the sequence, but rather that a higher resolution copy of the image currently displayed be sent. Alternatively, the physician may request that the entire sequence be sent at higher resolution.

It is contemplated that in many cases, particularly normal studies and routine follow up, full resolution images are never requested for all views. However, in a preferred embodiment the full resolution images are available on demand and under the control of the reviewing physician.

In some embodiments of the present invention, the reviewer may elect to archive reviewed images. In these embodiments the selected images may be retrieved from the stored full resolution set and transmitted to an appropriate archive. An archive may be located at the same location as the reviewing station 14 or at any other suitable location.

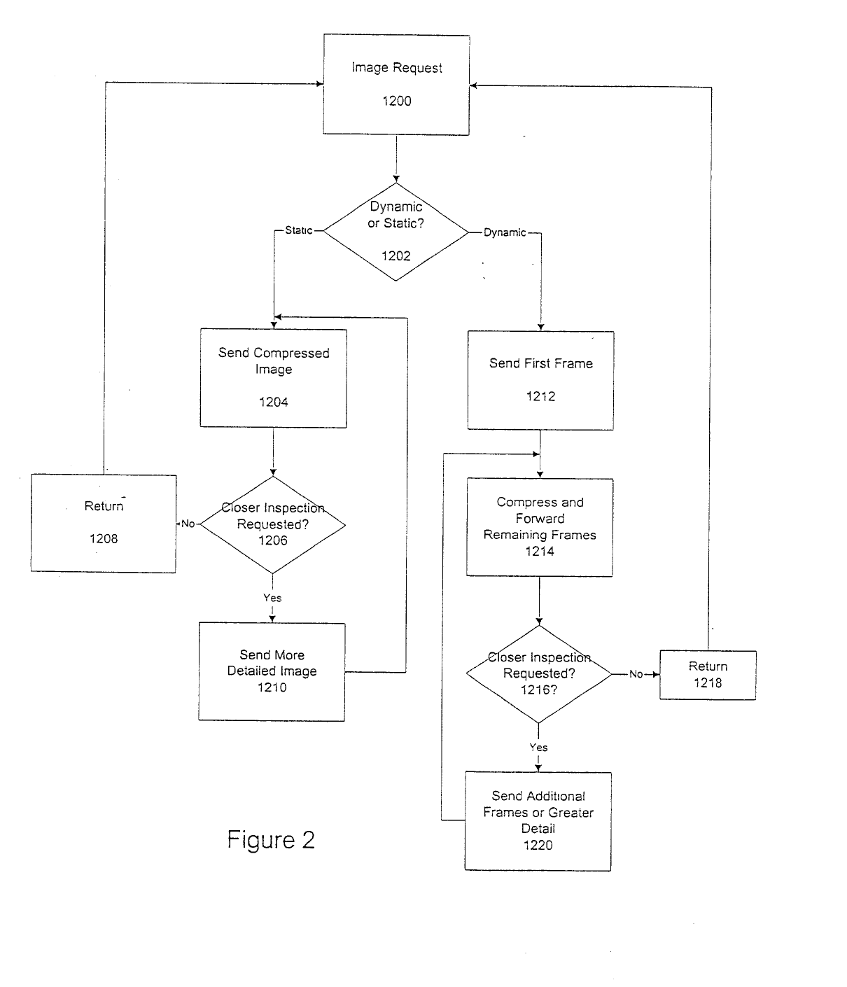

FIG. 2 presents a more detailed representation of adaptive review step 120 according to some embodiments of the invention. As indicated, adaptive review 120 begins with an image request at step 1200. Step 1202 determines whether the image request is for a static image (for example, an x-ray) or a dynamic sequence of images (for example, a sonogram scan).

If the request 1200 is for a static image, the system 10 causes a compressed image to be transmitted over the network 16 at step 1204. As described herein, the image may be compressed according to preselected criteria to optimize resolution and transmission efficiency.

The system 10 checks for a request for closer inspection of the image at step 1206. If no such request is received, the system 10 returns as indicated at step 1208. If a closer inspection request is received at step 1206, the system 10 causes a more detailed (higher resolution) version of the image to be communicated at step 1210. The system 10 may loop as indicated until no more request are detected.

If the request at step 1200 is determined at step 1202 to be for a dynamic series of images, the system 10 causes a compressed first frame to be communicated to review station 14 at step 1212. Again, compression is preselected to optimize transmission time and image resolution.

While the first frame is presented for review at step 1212, the system 10 causes the remaining images in the series to be compressed and forwarded at step 1214.

The system 10 also checks for requests for closer inspection at step 1216. Again, if none are received, the system 10 may return as indicated at step 1218. Otherwise, the system 10 may send additional frames in the series, or frames of greater resolution at step 1220. The system 10 may loop as indicated until no more requests are detected.

FIG. 3 illustrates a system 10 according to an embodiment of the present invention. As shown, system 10 includes a server 12. The server 12 may include any service and file providing processor device suitable for processing client device requests.

While a single server 12 is indicated in FIG. 3, multiple servers, distributed servers, or other suitable configuration of servers may be implemented. The system 10 also includes a review station 14. The review station 14 includes a suitable client device for accessing the server 12 over the network 16. For example, review station 14 may include a network terminal, a processor workstation, a personal computer, a portable computer, a personal digital assistant, a Web-enabled cellular phone, an Internet compatible television, or other processor device.

The server 12 and the review station 14 communicate over the network 16. The network 16 may comprise any interconnected processor network. For example, network 16 may comprise a local area network, a wide area network, the Internet, an intranet, or other suitable network. Communication over the network 16 may be accomplished in a wired or wireless fashion.

The system 10 may also include an acquiring station 18. The acquiring station 18 may comprise a diagnostic device capable of producing diagnostic clinical images suitable for transmission over network 16. For example, acquiring station 18 may comprise an ultrasound device, an angio-cardiogram device, an x-ray device, a magnetic resonance imager, or other suitable imaging device. As indicated in FIG. 3, the acquiring station 18 may communicate over the network 16 or, as indicated by dashed line, directly with the server 12.

The system 10 also may include an archive 20. The archive 20 may comprise a suitable storage device capable of storing selected images. The dashed box representation of the archive 20 indicates that archive 20 may be located at any suitable location. For example, the archive 20 may be located at the review station 14, at server 12, or at another location in communication with the network 16.

As described herein, the invention may reduce the size of the data actually transmitted by as much as 30:1 or more in addition to the lossless compression of 30:1 afforded by Clinical Adaptive Compression, as described in co-pending provisional application titled, “Method and Apparatus for Providing Clinically Adaptive Compression of Image Data,” by the same inventor, U.S. Provisional Application No. 60/222,952. This data reduction and/or compression makes the transmission of echocardiography exams over standard Internet connections a practical proposition.

Assuming a typical digital acquisition protocol for a routine echocardiogram examination comprising 16 views of 4 cardiac cycles and a heart rate of 60 beats per minute. At a frame rate of 30 Hz, this would be 120 frames per view or 1,920 frames total. If each frame is 900 kilobytes, the relative data sizes would be as shown in Table I below:

TABLE I

| | Approximate | | Time to transmit | |
|---|---|---|---|---|
| Data Format | Size | Compression | by ISDN 128 kbs | |
| Uncompressed | 1.8 Gbytes | 0 | >30 | hours |
| | (1,800 Mbytes) | | | |
| Standard Lossless | 450 Mbytes | 4:1 | 8 | hours |
| Compression | | | | |
| Clinical Adaptive | 60 Mbytes | 30:1 | 1 | hours |
| (Compression lossless) | | | | |
| With Workflow | 4 Mbytes | 360:1 | 4 | minutes |
| Adaptive Review | | | | |

Assuming that the reviewer requests a single frame for every view as an overview and 5 views of 30 frames (1 cardiac cycle) in detail, even if the reviewer requested more detail frames, say 25%, for example, the total time to transmit and review would still be less than 15 minutes using this approach.

By comparison, using industry standard compression techniques the data sizes would be as indicated in Table II:

TABLE II

| | | | Time to Transmit | |
|---|---|---|---|---|
| Data Format | Approximate Size | Compression | by ISDN (128 kbs) | |
| Uncompressed | 1.8 Gbytes | 0 | >30 | hours |
| | (1,800 Mbytes) | | | |
| Motion JPEG | 120 Mbytes | 15:1 | 2 | hours |
| (DVS) | | | | |
| MPEG-1 | 30 Mbytes | 60:1 | 30 | minutes |
| Clinical Adaptive | 18 Mbytes | 100:1 | 18 | minutes |
| Compression | | | | |
| (compact) | | | | |
| With Workflow | 1.5 Mbytes | 1200:1 | 1.5 | minutes |
| Adaptive Review | | | | |

Other embodiments, uses, and advantages of the present invention will be apparent to those skilled in the art from consideration of the specification and practice of the invention disclosed herein. It is understood that the present invention may be used with any image where the content and layout is known by the compressor, such as seismographic images, x-rays of inert objects, or other types of images. The specification and examples should be considered exemplary only. The intended scope of the invention is only limited by the claims appended hereto.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for transmitting a plurality of clinical images from a database of clinical images to a reviewer over a network, the method comprising:
providing a very low resolution copy of at least some of the clinical images from the database to the reviewer such that the reviewer can request an image for review;
receiving a request for a first clinical image from the reviewer;
transmitting a low resolution copy of the first clinical image in a relatively highly compressed form to the reviewer;
preparing a relatively less compressed and lossy higher resolution copy of the first clinical image at least in part simultaneously with transmitting the lower resolution copy of the first clinical image to the reviewer; and
upon receipt of a request for higher resolution, transmitting the higher resolution copy of the first clinical image to the reviewer.

2. The method of claim 1, wherein the higher resolution copy of the first clinical image comprises higher spatial resolution than the lower resolution copy of the first clinical image.

3. The method of claim 1, wherein the higher resolution copy of the first clinical image comprises higher temporal resolution than the lower resolution copy of the first clinical image.

4. The method of claim 1, wherein the clinical images comprise ultrasound images from a patient examination.

5. A method for transmitting a plurality of clinical images from a database of clinical images to a reviewer over a network, the method comprising:
providing a very low resolution copy of at least some of the clinical images from the database to the reviewer, wherein each very low resolution copy is associated with a dynamic sequence of images, such that the reviewer can request an image for review;
receiving a request for a first clinical image from the reviewer;
transmitting a low resolution copy of an intermediate image from the dynamic sequence of images associated with the first clinical image in a relatively highly compressed form to the reviewer;
preparing similarly low resolution copies of first additional images from the dynamic sequence of images associated with the first clinical image at least in part simultaneously with transmitting the intermediate image;
transmitting the low resolution copies of the first additional images to the reviewer;
preparing similarly low resolution copies of second additional images from the dynamic sequence of images associated with the first clinical image at least in part simultaneously with transmitting the first additional images; and
transmitting the low resolution copies of the second additional images to the reviewer.

6. The method of claim 5, wherein the preparation and transmission of additional images can be interrupted by the reviewer.

7. The method of claim 6, wherein the reviewer interruption may include a request for higher resolution images, the method further comprising the steps of:
receiving a request for higher resolution images;
transmitting a high resolution copy of an intermediate image from the dynamic sequence of images associated with the first clinical image in a relatively less compressed form to the reviewer;
preparing similarly high resolution copies of first additional images from the dynamic sequence of images associated with the first clinical image at least in part simultaneously with transmitting the intermediate image; and
transmitting the high resolution copies of the first additional images to the reviewer.

8. A system for transmitting clinical images from a database of images to a reviewer comprising:
a server comprising a processing unit, a storage device containing the database of images, and first software capable of running on the processing unit, the first software adapted to retrieve, compress, and transmit clinical images from the database of images;
a review station accessible to the reviewer and connected to the server through a network, the review station comprising a processing unit, a display capable of displaying clinical images from the database of images, and second software adapted to request, receive and display clinical images from the database of images;
wherein the first software is adapted to receive requests from the second software for at least one specified clinical image from the database of images, and upon receipt of such request compresses the requested at least one clinical image using a relatively low resolution compression scheme, and transmits the low resolution compressed image to the review station for display; and further
wherein the first software is adapted to receive requests from the second software for higher resolution, and upon receipt of such request compresses the specified at least one clinical image using a relatively high resolution compression scheme, and transmits the high resolution compressed image to the review station for display.

9. The system of claim 8, wherein the first software is further adapted to prepare the higher resolution compressed image at least in part simultaneously with transmission of the low resolution compressed image to the review station.

10. The system of claim 8, wherein the database of images comprises images from ultrasound examinations.

11. The system of claim 8, wherein the higher resolution compression scheme does not remove any clinically relevant information from the compressed image.
